(19) United States
(12) Patent Application Publication
(10) Pub. No.: US 2006/0109815 A1
(43) Pub. Date: May 25, 2006

(54) System and method for dynamic frequency selection in a multihopping wireless network

(76) Inventors: Sebnem Z. Ozer, Altamonte Springs, FL (US); Samer Hanna, Sanford, FL (US); Keith J. Goldberg, Casselberry, FL (US); William Vann Hasty JR., Lake Forest, FL (US)

Correspondence Address: MOTOROLA, INC;INTELLECTUAL PROPERTY SECTION, LAW DEPT, 8000 WEST SUNRISE BLVD, FT LAUDERDAL, FL, 33322, US

(21) Appl. No.: 11/268,101

(22) Filed: Nov. 7, 2005

Related U.S. Application Data
(60) Provisional application No. 60/625,114, filed on Nov. 5, 2004.

(51) Int. Cl. H04Q 7/00

(52) U.S. Cl. 370/329

(57) ABSTRACT

A system and method for dynamic frequency selection at one or more access points (APs 106) in a multihop wireless network (100). The system and method maintain at the APs (106) a table comprising end-to-end network channel information that is indicative of the degree of channel performance in the network (100). The APs (106) are capable of dynamically selecting frequencies in response to the network channel information in the table.

This application claims the benefit of U.S. Provisional Application No. 60/625,114, filed Nov. 5, 2004, the entire content being incorporated herein by reference.

### FIELD OF THE INVENTION

The present invention relates to wireless communication networks and, more particularly, to a system and method for dynamically selecting frequencies in a multihopping wireless communication network.

### BACKGROUND

In recent years, a type of mobile communications network known as an ad-hoc network has been developed. In this type of network, each mobile node is capable of operating as a base station or router for the other mobile nodes, thus eliminating the need for a fixed infrastructure of base stations. As can be appreciated by one skilled in the art, network nodes transmit and receive data packet communications in a multiplexed format, such as time-division multiple access (TDMA) format, code-division multiple access (CDMA) format, or frequency-division multiple access (FDMA) format.

More sophisticated ad-hoc networks are also being developed which, in addition to enabling mobile nodes to communicate with each other as in a conventional ad-hoc network, further enable the mobile nodes to access a fixed network and thus communicate with other mobile nodes, such as those on the public switched telephone network (PSTN), and on other networks such as the Internet. Details of these advanced types of ad-hoc networks are described in U.S. patent application Ser. No. 09/897,790 entitled “Ad Hoc Peer-to-Peer Mobile Radio Access System Interfaced to the PSTN and Cellular Networks”, filed on Jun. 29, 2001, in U.S. patent application Ser. No. 09/815,157 entitled “Time Division Protocol for an Ad-Hoc, Peer-to-Peer Radio Network Having Coordinating Channel Access to Shared Parallel Data Channels with Separate Reservation Channel”, filed on Mar. 22, 2001, now U.S. Pat. No. 6,807,165, and in U.S. patent application Ser. No. 09/815,164 entitled “Prioritized-Routing for an Ad-Hoc, Peer-to-Peer, Mobile Radio Access System”, filed on Mar. 22, 2001, now U.S. Pat. No. 6,873,839, the entire content of each being incorporated herein by reference.

As communication systems increasingly permit communication mobility, the bandwidth capacity of a communication channel, or channels, available to the communication system between sending and receiving stations is sometimes limited. Also, even using techniques in which a single channel can be used for communication by a plurality of stations, bandwidth capacity can still be limited because more than one network can use common frequencies of a channel. Accordingly, networks must be able to dynamically select the frequency bands over which they communicate. Moreover, networks should be able to select frequencies dynamically so that more than one network does not concurrently attempt to use the same frequency. An Institute of Electrical and Electronics Engineers (IEEE) Standard 802.11 system or a Hyper Local Area Network (HyperLAN) system, for example, requires that a mobile station (STA) be capable of tuning to a portion of the frequency band not currently used by a basic service set (BSS). Once tuned to the portion of the frequency band, the mobile station is required to measure for the presence of interference. Once the measurement is made, the mobile station sends a report pertaining to the measurement to an access point (AP) of the BSS. This procedure is referred to as dynamic frequency selection (DFS).

A process similar to DFS can be performed in wireless local area networks (WLANs). However, in WLANs with single transceiver devices, one of the main objectives is to choose a frequency that is not used in the neighborhood to avoid overlapping BSSs. On the other hand, in multihopping networks, connectivity is one of the main objectives, and therefore it can be desirable to choose the same frequency of a neighbor whose transmissions have strong signal quality. It is also desirable for a multihopping network to be capable of performing cross-layer optimization between DFS and routing protocols to minimize frequency scanning time and the amount of time to establish routes between nodes.

### BRIEF DESCRIPTION OF THE FIGURES

The accompanying figures, where like reference numerals refer to identical or functionally similar elements throughout the separate views and which together with the detailed description below are incorporated in and form part of the specification, serve to further illustrate various embodiments and to explain various principles and advantages all in accordance with the present invention.

FIG. 1 is a block diagram of an example ad-hoc wireless communications network including a plurality of nodes employing a system and method in accordance with an embodiment of the present invention;

FIG. 2 is a block diagram illustrating an example of a node employed in the network shown in FIG. 1;

FIG. 3 is a diagram illustrating an example network formation scenario where an access point (AP) binds with an intelligent access point (IAP);

FIG. 4 is a diagram illustrating an example of a dynamic scenario where an AP rebinds with a new IAP on a new channel;

FIGS. 5-8 are flowcharts illustrating examples of operations performed during a network formation scenario according to embodiments of the present invention;

FIGS. 9 and 10 are flowcharts illustrating examples of operations performed during a dynamic network scenario according to embodiments of the present invention;

FIG. 11 is a diagram illustrating an exemplary format of a “hello” message transmitted by nodes in the network shown in FIG. 1; and

FIG. 12 is a diagram illustrating an example of a routing information element transmitted by nodes in the network shown in FIG. 1.

Skilled artisans will appreciate that elements in the figures are illustrated for simplicity and clarity and have not necessarily been drawn to scale. For example, the dimensions of some of the elements in the figures may be exaggerated relative to other elements to help to improve understanding of embodiments of the present invention.

### DETAILED DESCRIPTION

Before describing in detail embodiments that are in accordance with the present invention, it should be observed that the embodiments reside primarily in combinations of method steps and apparatus components related to a system and method for dynamically selecting frequencies in a multihopping wireless communication network. Accordingly, the apparatus components and method steps have been represented where appropriate by conventional symbols in the drawings, showing only those specific details that are pertinent to understanding the embodiments of the present invention so as not to obscure the disclosure with details that will be readily apparent to those of ordinary skill in the art having the benefit of the description herein.

In this document, relational terms such as first and second, top and bottom, and the like may be used solely to distinguish one entity or action from another entity or action without necessarily requiring or implying any actual such relationship or order between such entities or actions. The terms “comprises,” “comprising,” or any other variation thereof, are intended to cover a non-exclusive inclusion, such that a process, method, article, or apparatus that comprises a list of elements does not include only those elements but may include other elements not expressly listed or inherent to such process, method, article, or apparatus. An element proceeded by “comprises . . . a” does not, without more constraints, preclude the existence of additional identical elements in the process, method, article, or apparatus that comprises the element.

It will be appreciated that embodiments of the invention described herein may be comprised of one or more conventional processors and unique stored program instructions that control the one or more processors to implement, in conjunction with certain non-processor circuits, some, most, of all of the functions of a system and method for dynamically selecting frequencies in a multihopping wireless communication network as described herein. The non-processor circuits may include, but are not limited to, a radio receiver, a radio transmitter, signal drivers, clock circuits, power source circuits, and user input devices. As such, these functions may be interpreted as steps of a method for dynamically selecting frequencies in a multihopping wireless communication network. Alternatively, some or all functions could be implemented by a state machine that has no stored program instructions, or in one or more application specific integrated circuits (ASICs), in which each function or some combinations of certain of the functions are implemented as custom logic. Of course, a combination of the two approaches could be used. Thus, methods and means for these functions have been described herein. Further, it is expected that one of ordinary skill, notwithstanding possibly significant effort and many design choices motivated by, for example, available time, current technology, and economic considerations, when guided by the concepts and principles disclosed herein will be readily capable of generating such software instructions and programs and ICs with minimal experimentation.

As described in more detail below, the present invention provides a system and method for performing an efficient frequency selection scheme at one or more access points and/or stations in a wireless communication network. That is, the system and method provide a mechanism for scanning, evaluating, selecting and switching channels in a multihopping wireless network, in order to maximize network connectivity and to ensure a desired level of network performance. Moreover, the system and method of the present invention provide a distributed and dynamic algorithm at one or more nodes to resolve issues related to network dynamics, such as sharing a transmission medium with other devices and the mobility of access points and stations.

The distributed method dynamically selects frequencies to satisfy a desired set of requirements and to improve system performance in terms of throughput, delay, jitter, connectivity, reliability and fairness characteristics, while performing cross-layer optimization by providing interdependencies between frequency and route selection. The dynamic frequency selection process is performed at one or more access points (APs) in a multihop wireless network, and maintains at the one or more APs a table comprising network channel information that is indicative of the degree of channel performance in the network. The one or more APs 106 is thus capable of dynamically selecting frequencies in response to the network channel information in the table.

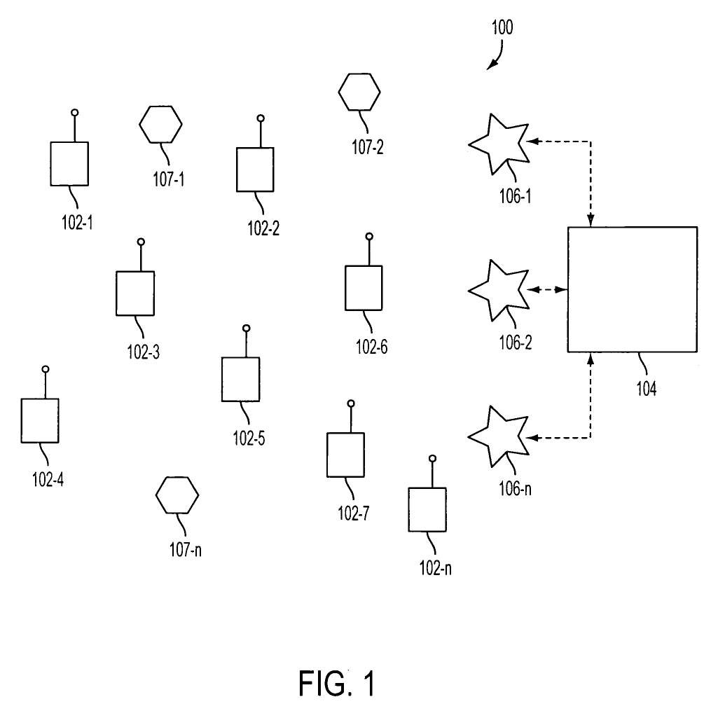

FIG. 1 is a block diagram illustrating an example of an ad-hoc packet-switched wireless communications network 100 employing an embodiment of the present invention. Specifically, the network 100 includes a plurality of user terminals 102-1 through 102-n (referred to generally as nodes 102, mobile nodes 102 or stations (STAs) 102). The STAs 102 can be wireless or can communicate over wired connections. The network 100 further can, but is not required to, include a fixed network 104. The fixed network 104 can include, for example, a core local area network (LAN), and a plurality of servers and gateway routers to provide network nodes with access to other networks, such as other ad-hoc networks, the public switched telephone network (PSTN) and the Internet. The fixed network 104 can further comprise a bridge component that broadcasts, for example, Institute of Electrical and Electronics Engineers (IEEE) Standard 802.2 updates that are used by Ethernet switches to update port routing information. A plurality of intelligent access points (IAPs) 106-1, 106-2, . . . 106-n (referred to generally as nodes 106, access points (APs) 106 or IAPs 106), provide nodes 102 with access to the fixed network 104. For purposes of this discussion, APs 106 are the same as IAPs 106, except they can be mobile and communicate with the core network 104 via an IAP 106 that is coupled to the core network 104.

The network 100 further includes a plurality of fixed routers 107-1 through 107-n (referred to generally as nodes 107, wireless routers (WRs) 107 or fixed routers 107) for routing data packets between other nodes 102, 106 or 107. It is noted that for purposes of this discussion, the nodes discussed above can be collectively referred to as “nodes 102, 106 and 107”, or simply “nodes”. As can be appreciated by one skilled in the art, the nodes 102, 106 and 107 are capable of communicating with each other directly, or via one or more other nodes 102, 106 or 107 operating as a router or routers for packets being sent between nodes, as described in U.S. patent application Ser. No. 09/897,790, and U.S. Pat. Nos. 6,807,165 and 6,873,839, referenced above.

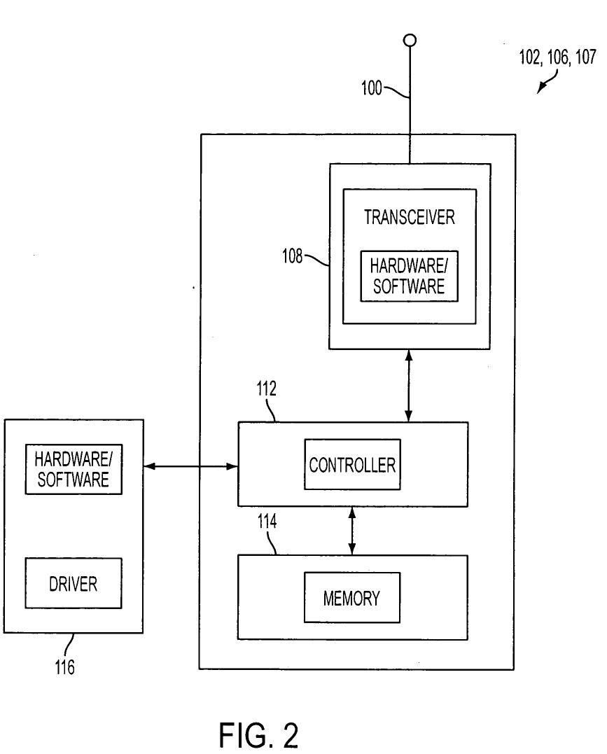

As shown in FIG. 2, each node 102, 106 and 107 includes a transceiver, or modem 108, which is coupled to an antenna 110 and is capable of receiving and transmitting signals, such as packetized signals, to and from the node 102, 106 or 107, under the control of a controller 112. The packetized data signals can include, for example, voice, data or multimedia information, and packetized control signals, including node update information.

Each node 102, 106 and 107 further includes a memory 114, such as a random access memory (RAM) that is capable of storing, among other things, routing information pertaining to itself and other nodes in the network 100. As further shown in FIG. 2, certain nodes, especially mobile nodes 102, can include a host 116 which may consist of any number of devices, such as a notebook computer terminal, mobile telephone unit, mobile data unit, or any other suitable device. Each node 102, 106 and 107 also includes the appropriate hardware and software to perform Internet Protocol (IP) and Address Resolution Protocol (ARP), the purposes of which can be readily appreciated by one skilled in the art. The appropriate hardware and software to perform transmission control protocol (TCP) and user datagram protocol (UDP) may also be included.

As discussed above, it is desirable for the nodes 102, 106, and 107 of the network 100 to be capable of dynamically selecting frequencies, for example, to satisfy a desired set of requirements, and/or to improve system performance in terms of throughput, delay, jitter, connectivity, reliability and/or fairness characteristics. Hence, in accordance with the embodiments of the present invention described herein, a distributed and dynamic algorithm can be provided at one or more access points (e.g., APs 106) to dynamically scan, evaluate, select and switch channels for communication in the network 100. The algorithm is thus capable of resolving issues related to network dynamics, such as multiple nodes 102, 106, 107 sharing a transmission medium and the mobility of APs 106 and STAs 102.

Before discussing the embodiments of the present invention in more detail, further components of the network 100 will now be described. For example, a wireless distribution system (WDS) is defined herein as a system that handles wireless packet communication between APs 106, for example, and which includes the media access control (MAC) layer within each wireless node. The media center extender (MCX) is software components that manage ad hoc routing, neighbor management, and other high-level wireless functions to enable mesh networking. An Access Distribution System (ADS) is a distribution system used by STAs 102 to communicate with an AP 106, and can be a wired (e.g. Ethernet) or wireless (e.g. 802.11) distribution system. Dynamic Frequency Selection (DFS) is a mechanism to scan, evaluate, select and switch the channels, for example, for APs 106 and STAs 102. It should be noted that the definitions of components used herein are for exemplary purposes to describe the embodiments of the present invention, and should not be interpreted to limiting the components. Rather, the components can be embodied in a suitable manner as would be understood by one skilled in the art.

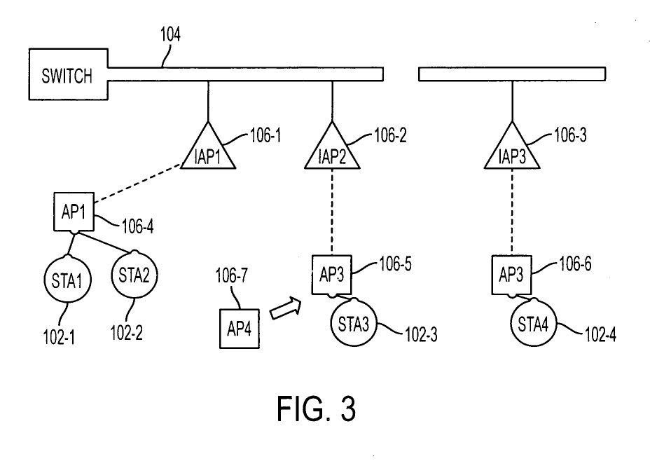

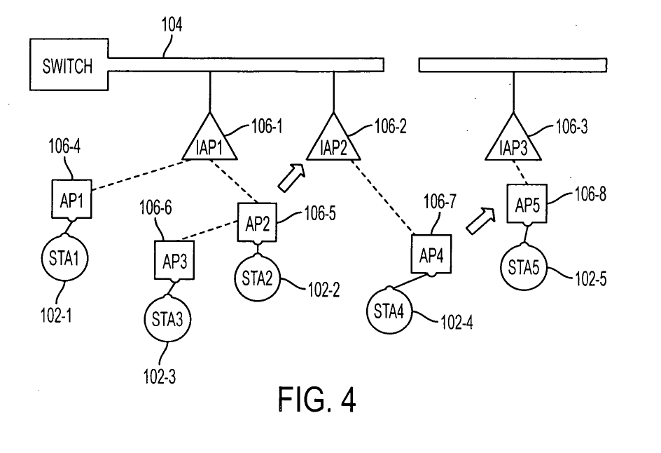

FIGS. 3 and 4 are conceptual block diagrams illustrating an embodiment of components of the network 100 shown in FIG. 1 for use in describing different scenarios in which the embodiments of the present invention described herein are used. The scenarios described include initial network formation and network topology changes. Network formation occurs when APs 106 power up and bind with respective IAPs 106 as shown in FIG. 3, or when APs 106 power up and form an ad-hoc network without binding to IAPs 106. Dynamic scenarios pertaining to network topology changes that occur, for example, when APs 106 associate with new IAPs 106 on a different channel as shown in FIG. 4.

Two states of operation are also discussed, namely, the infrastructure state and the ad-hoc state. In the infrastructure state, each AP 106 is bound with a respective IAP 106, while in an ad-hoc mode the APs 106 are not bound to any IAP 106. Furthermore, the ad-hoc state includes two states, namely, an ad-hoc state where AP 106 prefers the least used channel in order not to overlap with channels used by other base service sets (BSSs), and an ad-hoc state where AP 106 merges its channel use with other BSSs.

Furthermore, as discussed in more detail below, the exemplary operations performed by the embodiments of the present invention vary depending on the channel set (e.g., a hard-coded channel set) used by the APs 106 and the state of the APs 106 (e.g., whether they are operating in the infrastructure state or ad hoc state). In the network formation scenarios, the operations pertaining to APs 106 in an infrastructure state can be performed, for example, when an AP 106 is prohibited from operating in an ad-hoc state. In the dynamic scenarios, the policies depend upon the current state of the APs 106. For example, if the current state is an infrastructure state, the AP 106 will try to continue in the infrastructure state. Also, an AP 106 may continue in an ad-hoc state if it cannot bind with an IAP 106, or its state may change and it may be prohibited from continuing in an ad-hoc state and must bind to an IAP 106.

Network Formation Scenarios

As discussed above, FIG. 3 illustrates an example network formation scenario. In particular, FIG. 3 displays a portion of the network 100 as shown in FIG. 1 where APs 106-4 through 106-7 select any suitable IAP 106 with which to bind to access the network 104. A network formation scenario begin with initialized IAPs 106-1 through 106-3 that are connected to the network 104 or with initialized APs 106-4 through 106-7 that are formed into ad-hoc networks. Channels for the IAPs 106-1 through 106-3 may be preconfigured or selected dynamically. Since IAPs 106-1 through 106-3 are connected to the wired network 104, the desired frequency for an IAP 106-1 through 106-3 is the frequency with minimum interference and load. IAPs 106-1 through 106-3 can share channel related information with other geographically overlapping IAP subnets using wireless and/or wireline communications.

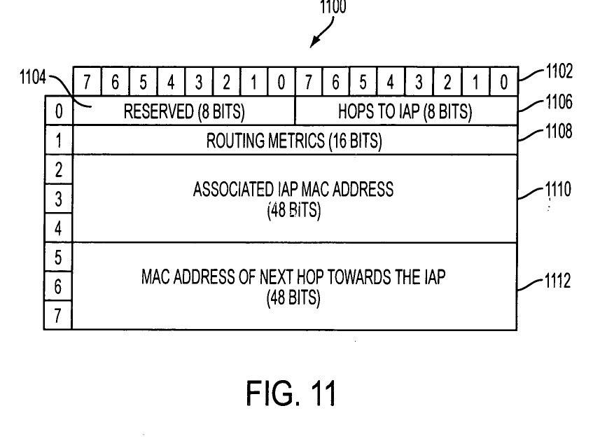

The IAPs 106-1 through 106-3 and APs 106-4 through 106-7 periodically broadcast “hello” message packets that carry routing information and management frames such as beacons. An example of the format of a “hello” message is shown in FIG. 11. As illustrated, the hello message 1100 in this example comprises fields 1102 including a reserved eight bits 1104 and eight bits of information 1106 indicating the number of hops to an IAP. The hello message 1100 further includes a 16-bit routing metrics field 1108, a 48-bit associated IAP MAC address field 1110, and a 48-bit MAC address field 1112 indicating the MAC address of the next hop toward the IAP.

In this example, when an AP 106-4 through 106-7 powers up, it will start a network discovery and selection process. Moreover, the supported channels of APs 106-4 through 106-7 may be different within network 100.

It will be appreciated by those of ordinary skill in the art that any suitable technique can be used for network formation scenarios. Suitable techniques for initial network formation include, for example, scanning the hard-coded channel until at least one IAP 106, or an AP 106 bound to an IAP 106, is located, and starting a process to establish routes to that AP 106 or IAP 106. The scanning process is repeated when no IAP 106 or AP 106 bound to an IAP 106 is found.

Another suitable technique involves scanning the hard-coded channel until at least one IAP 106, or an AP bound to an IAP 106 is located, and starting a process to establish routes to that AP 106 or IAP 106. If no such IAP 106 or AP 106 is found, then the AP 106 that is initializing operates on the selected channel in an ad-hoc mode.

Another suitable technique involves scanning the available channels until at least one IAP 106, or an AP 106 bound to an IAP 106, is located, and starting a process to establish routes to that AP 106 or IAP 106. If all available channels are scanned and no such IAP 106 or AP 106 is found, then the scanning process is repeated. Another technique involves scanning the available channels until at least one IAP 106, or an AP 106 bound to an IAP 106, is located, and starting a process to establish routes to that AP 106 or IAP 106. If all available channels are scanned and no such IAP 106 or AP 106 is found, then a channel is selected according to the rules set for merging an AP 106 with other BSSs as can be appreciated by one skilled in the art.

When the AP 106 discovers that it cannot meet desired conditions, moves from the range of its IAP 106, detects that its quality of communication has degraded, or is in ad-hoc mode and wants to join an infrastructure network (e.g., fixed network 104), the AP 106 will start a new network discovery and selection process as shown in FIG. 4. It is also noted that, if the channel is hard-coded, the AP 106 will continue to communicate over that channel unless the desired conditions are not satisfied, in which event the communication will cease. The following techniques can be performed for the new network discovery scenario.

According to one technique, the channels are scanned until at least one IAP 106, or an AP 106 bound to an IAP 106, is found, and a process establish routes to that AP 106 or IAP 106 is started. If all available channels are scanned and no such IAP 106 or AP 106 is found, then the scanning process is repeated. In another technique, the channels are scanned until at least one IAP 106, or an AP 106 bound to an IAP 106, is found, and a process establish routes to that AP 106 or IAP 106 is started. If all available are scanned and no such IAP 106 or AP 106 is found, a channel is selected according to the rules set for merging an AP 106 with other BSSs as can be appreciated by one skilled in the art. If the AP 106 is currently in an ad-hoc mode, the AP 106 may stay in this ad-hoc mode until the AP 106 makes further attempts to find an IAP 106.

It will be appreciated by those of ordinary skill in the art that the trigger for channel switching will depend on the available information that can be collected by the nodes 102, 106 and 107 so that the scanning overhead and channel switching for STAs 102 and APs 106 can be reduced. That is, a node 102, 106 or 107 can collect channel information in its neighborhood by collecting, for example, a priori information about possible routes to the fixed network 104 in the neighborhood. The node 102, 106 or 107 can actually scan the channel for a minimum time that will allow the node 102, 106 or 107 to select a best next hop to the fixed network 104. This collected information will enable the node 102, 106 or 107 to assess link quality and avoid mis-measurements. The a priori information will also help to reduce the route discovery time and scanning overhead as can be appreciated by one skilled in the art.

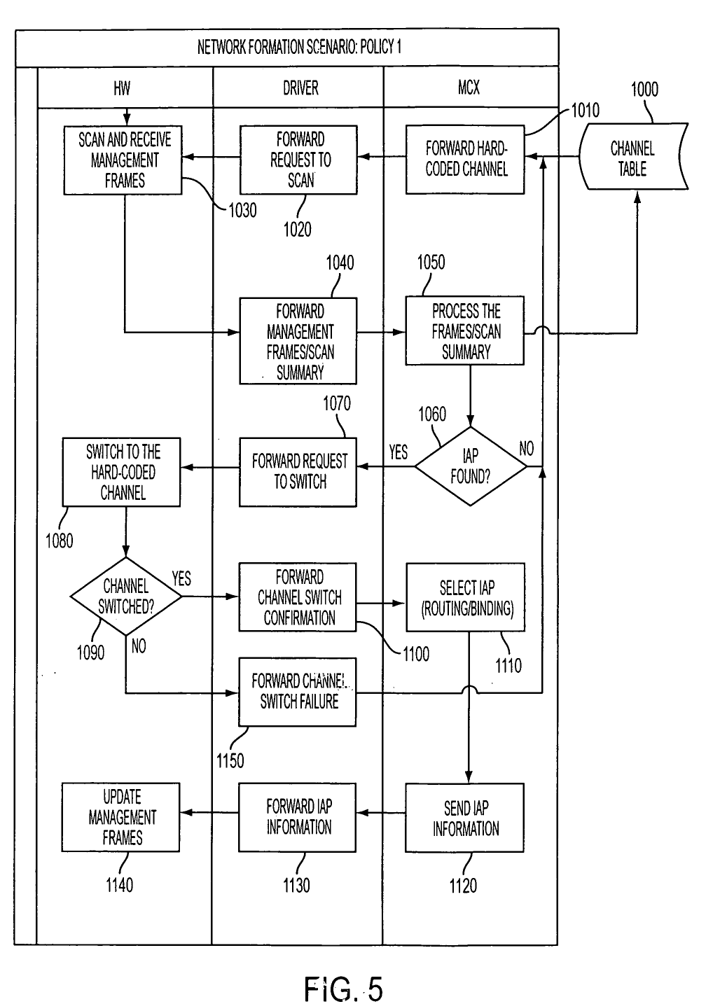

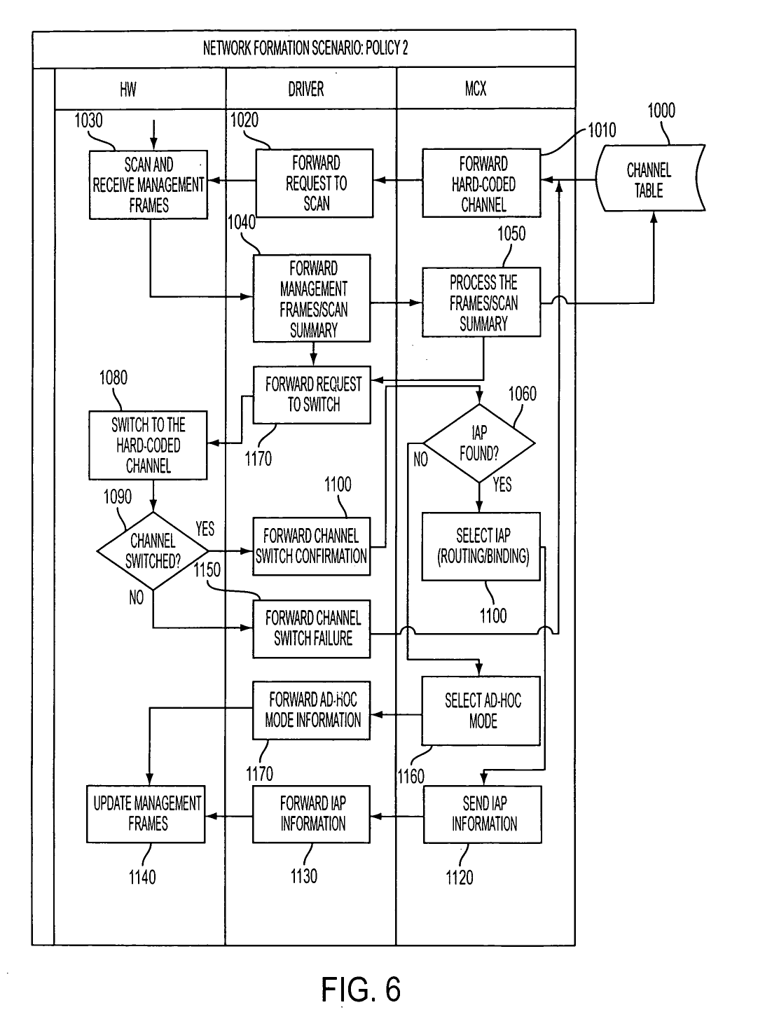

FIG. 5 is a flowchart depicting an example of operations performed for a network formation scenario by an embodiment of the present invention. It is noted that these operations, as well as those discussed below with regard to the flowcharts in FIGS. 6-10, can be performed by, for example, the controller 112 (see FIG. 2) and its related software and hardware. As indicated, in step 1000, a hard-coded channel selected from the supported channels available at the hardware (HW) is put in the channel table at the MCX. Details of the information included in a channel table are described below. The channel table information will be updated when the MCX receives new information from the HW.

When AP 106 initializes, MCX sends scan request with the hard-coded channel via the driver in step 1010. If the integrator chooses to bypass the MCX channel switching algorithm, the HW can initiate scan process, in this case the scan request from the MCX will be ignored. In step 1030, HW scans the channel and in step 1040, sends the management frames (with other received frames) or scan summary to the MCX. Management frames carry certain information that can be used to evaluate the channel. If the frames are forwarded, the MCX will extract the information as described in the channel table maintenance section below. If a summary of the scan process (such as the average values of the channel metrics that are the entries in the channel table) is forwarded, this information will be added to the table. If the HW does not send individual information such as node identifications (IDs), the optimization for the network and route selection may not be available.

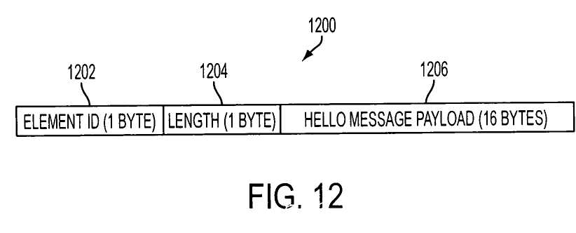

In step 1050, the MCX processes the channel information and updates the channel table as described below. Specifically, if an IAP 106 is found in step 1060, the MCX sends the channel switch request to the HW in step 1070. Otherwise, it returns to step 1010. In step 1080, the HW switches to the channel, as for example described in IEEE Standard 802.11h, and the HW sends the status of the channel switching to the MCX which updates the neighbor list that will be used for routing. If it is determined in step 1090 that the channel is to be switched, the driver forwards a confirmation message to the MCX in step 1100 indicating that the channel is to be switched, and the MCX in step 1110 initiates the authorization, routing and binding processes. The routing information (e.g., from the payload of a hello message) is sent as an information element from the MCX to the HW via the driver in steps 1120, 1130 and 1140 to be set as an information element. An information element can be created to distribute routing information included in the “hello” message 1100 as shown in FIG. 11. This information is set as an information element that can be added into beacons, probe responses and action management messages. An example of the format of the information element 1200 is shown in FIG. 12. In this example, the information element 1200 includes a one-byte element ID field 1202, a one-byte length field 1204 and a payload field 1206 which in this case is 16 bytes. If the Hello message payload changes, the new information will likewise be sent from the MCX to the HW. The update time may be reduced by selecting the frames to be processed based on the last update time and information change.

On the other hand, if it is determined in step 1090 that the channel is not switched, a forward channel switch failure is issued in step 1150, and the operations of the MCX returns to step 1010.

FIG. 6 is a flowchart depicting an example of operations for a network formation scenario in accordance with and embodiment of the present invention. As can be appreciated from the flowchart, the difference between the operations set forth in FIG. 5 and these operations is that AP 106 initializes with the hard-coded channel in steps 1070 and 1080 even though an IAP 106 is not found. If AP 106 later discovers an IAP 106 in the channel (step 1060), the AP 106 will become bound to that IAP 106. Furthermore, the steps following step 1090 are changed with the following addition. Namely, if it is determined in step 1090 that the channel is to be switched, the switch confirmation is made in step 1100 and the processing proceeds to step 1060. If an IAP 106 is found in step 1060, the MCX initiates the authorization, routing and binding processes beginning at step 1100 as shown. The routing information (e.g., from the payload of a hello message) is sent to HW via steps 1120, 1130 and 1140 as an information element as discussed above. However, if an IAP 106 is not found in step 1060, an on-demand routing process can be started according to traffic requirements in step 1160, and the routing information (from the payload of a hello message) is sent to the HW in step 1170 as an information element.

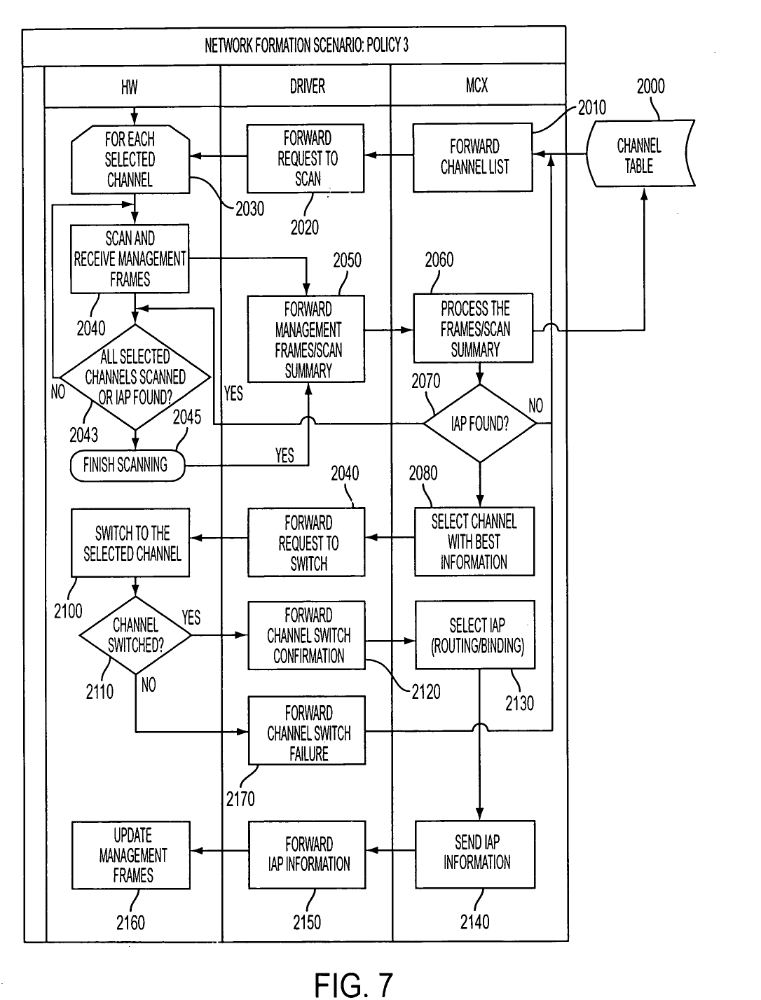

FIG. 7 is a flowchart depicting another example of operations for a network formation scenario according to an embodiment of the present invention. As indicated in step 2000, the supported channels available at the HW are put in the channel table at the MCX in step 2010. The channel table information will be updated when the MCX receives new information from the HW. When AP 106 initializes, the MCX sends scan request in steps 2020 and 2030. If the integrator chooses to bypass the MCX channel switching algorithm, the HW can initiate a scan process, and in this case the scan request from the MCX will be ignored. In steps 2040, 2043 and 2045, the HW scans the channel and sends the management frames (with other received frames) or scan summary to the MCX in step 2050. In step 2060, the MCX processes the channel information and updates the channel table as described below. If an IAP 106 is found in step 2070, the MCX selects the channel in step 2080, otherwise it returns to step 2010 as described above. That is, if individual link values are available, the MCX selects the channel that meets the regulations and has an available next hop with best route metric to IAP 106 and less neighborhood congestion. A cost metric (C) is then defined as discussed in more detail below.

In step 2090, the MCX sends the channel switch request to the HW. The MCX can decide the channel selection before all channels are scanned at the HW if the cost (C) described below is lower then a predetermined threshold. In step 2100, the HW switches to the channel as described in the IEEE Standard 802.11h. The HW sends the status of the channel switching to the MCX and the MCX updates the neighbor list that will be used for routing if the channel is switched. Specifically, if it is determined in step 2110 that the channel is switched, the HW sends this status to the MCX in step 2120 and the MCX initiates the authorization, routing and binding processes in step 2130. The routing information (e.g., from the payload of a hello message) is sent to HW via steps 2140, 2150 and 2160 to be set as an information element. However, if it is determined in step 2110 that the channel is not switched, this information is forwarded to the MCX in step 2170 and MCX returns to step 2010.

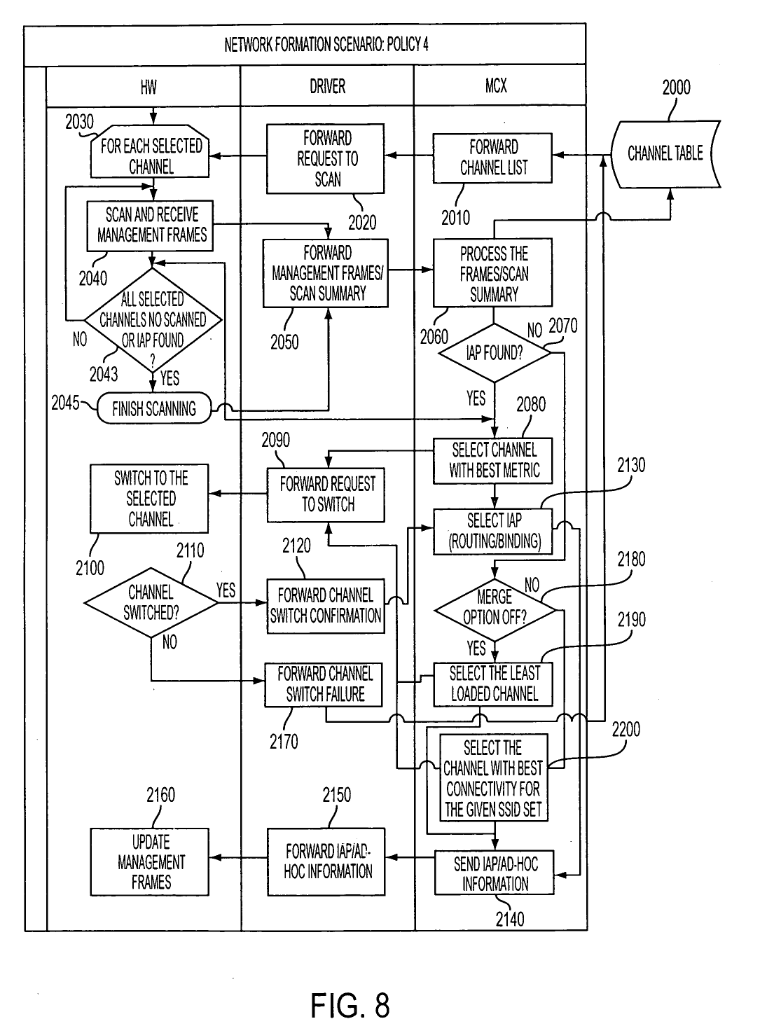

FIG. 8 is a flowchart illustrating another example of operations for a network formation scenario according to an embodiment of the present invention. As can be appreciated from this flowchart in view of the flowchart in FIG. 7, the difference between this process and that shown in FIG. 7 is that the AP 106 may continue with ad-hoc state until an IAP 106 is found (unless otherwise desired) in the selected channel or other supported channels (as described in the dynamic scenarios). The following steps in this exemplary process are as follows.

Specifically, if an IAP 106 is found in step 2070, the MCX selects the channel with the following rules. If individual link values are available, the process selects the channel that meets the desired conditions and has an available next hop with best route metric to IAP 106 and less neighborhood congestion as indicated by the cost metric (C). If an IAP 106 is not found in step 2070, the processing proceeds to step 2180. A set of service set identifiers (SSIDs) and broadcast service set identifiers (BSSIDs) may be examined to determine whether merging should occur. If it is determined in step 2180 that the AP 106 should not try to merge with another BSS, in step 2190 the MCX selects the channel that meets the desired conditions, is the least used (e.g., has the least number of neighbors) and has less neighborhood congestion. That is, the MCX selects the channel that meets the desired conditions, highest number of neighbors and less neighborhood congestion in case there are more than one channel with highest number of neighbors. However, if it is determined in step 2180 that the AP 106 should try to merge, the channel with the best connectivity (to reduce the effect of interference) will be selected in step 2200. For both the merge and non-merge condition, the processing then proceeds to step 2140, the routing information (e.g., from the payload of the hello message) is provided to the HW in steps 2140, 2150 and 2160 to be sent as an information element.

Dynamic Scenarios

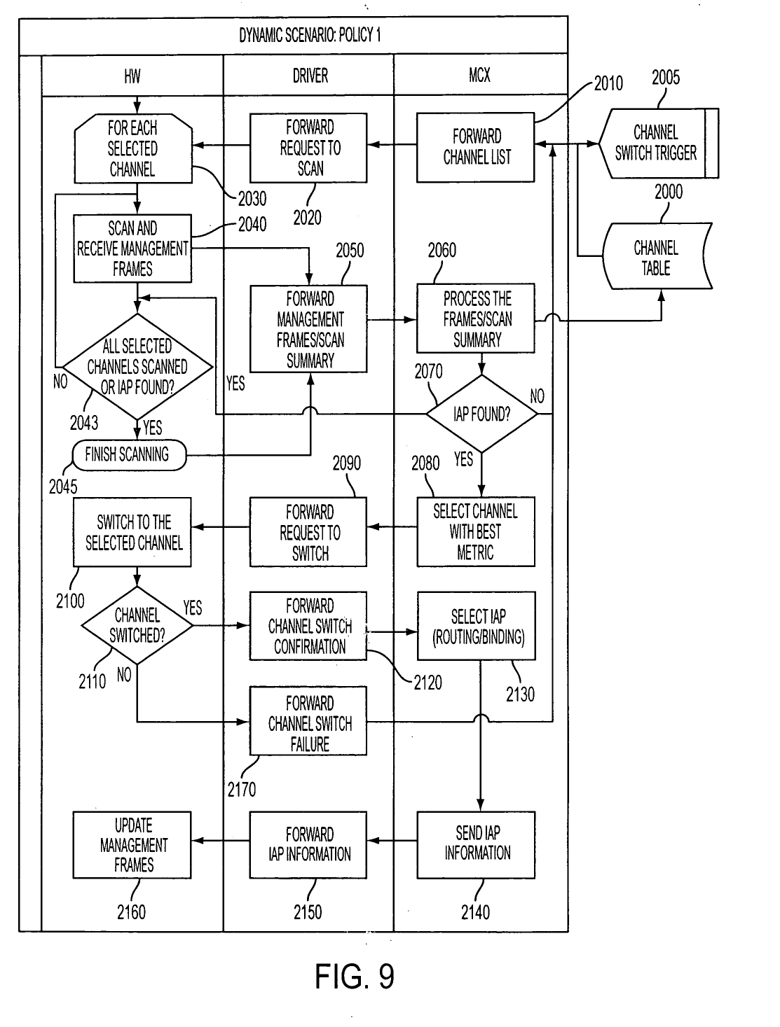

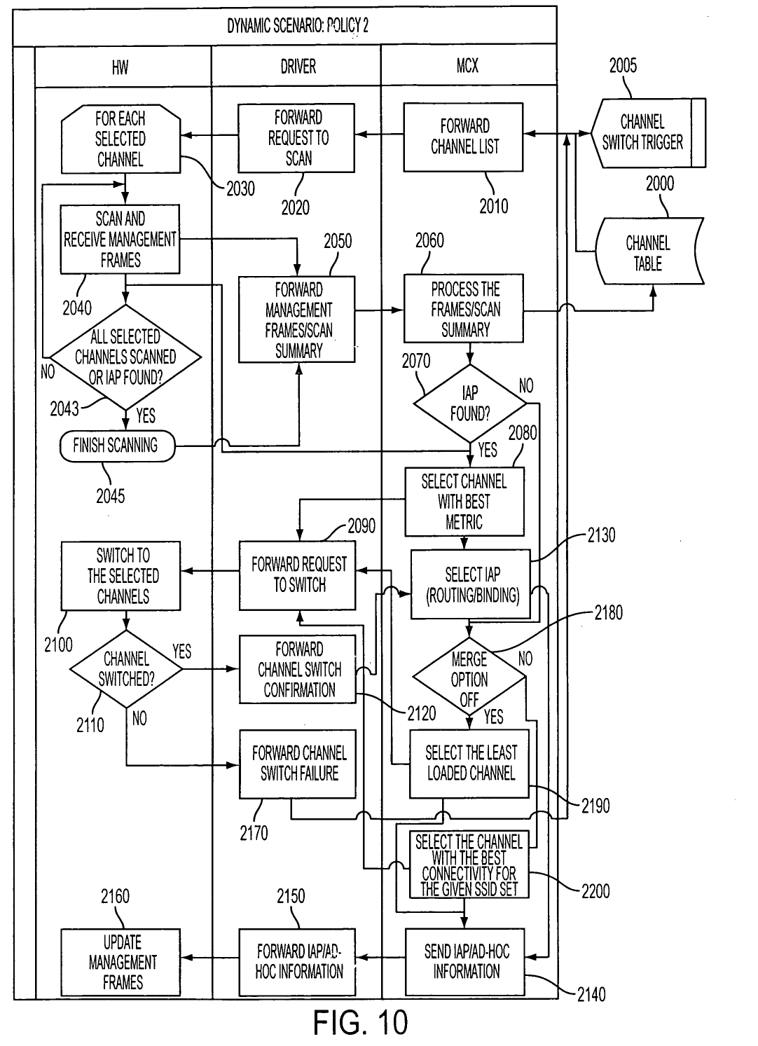

The system and method of the present invention is also useful for dynamically and efficiently selecting frequencies at one or more AP 106 nodes in the context of network topology changes or dynamic scenarios. The dynamic scenarios apply the same channel selection algorithms as described above with regard to FIGS. 5-8. The channel scan and selection algorithms are triggered by the MCX for the following cases. It is noted that these algorithms as depicted by flowcharts in FIGS. 9 and 10 are essentially identical to the flowcharts in FIGS. 7 and 8 with the exception of including the channel switch trigger step 2005.

If the current state of an AP 106 is the ad-hoc state, the AP 106 may request idle nodes 102, 106 or 107 in its range to scan for other channels to discover IAPs 106, or the AP 106 may receive autonomous reports from other nodes 102, 106 or. If these options are not supported, a periodic scan (Ps) can occur as discussed below.

On the other hand, if the AP 106 is currently operating in the infrastructure state, the AP 106 may request idle nodes in its range to scan for other channels to discover other IAPs 106 or may receive autonomous reports from other nodes 102, 106 or 107. These options may be used as a proactive method to have a priori knowledge about the neighborhood. The frequency of the scan requests may be adaptive depending on the current communications quality (such as route metric to IAP and neighborhood congestion). If these options are not supported, a periodic scan can be performed, such that the periodicity of the scan may be adaptive to communication quality will be implemented. If periodicity is set to zero, then AP 106 can start scan process after the association or route to the IAP 106 is lost, or the communication between neighbor nodes 102, 106 or 107 is broken.

Channel Switching

It is noted that when an STA 102 receives the channel switch announcement from its current associated AP 106, the STA 102 will switch the channel advertised by the AP 106, or the STA 102 will start a new BSS search in the same channel and will perform a channel evaluation algorithm to determine whether to switch channels. However, when a precursor AP 106 receives the channel switch announcement from a next hop AP 106, the precursor AP 106 will start a new route search in the same channel and perform a multihop channel evaluation algorithm to determine whether to switch channels as described above. The distributed information can be optimized, for example, neighbor APs 106 can monitor and save other APs 106 channel switching information. An AP 106 can send the channel switching information to its IAP 106 that can update its information, and can use this information to understand the network conditions.

If an IAP 106 switches to another channel, the bound APs 106 should be informed by the IAP 106 sending an end-to-end channel switch announcement information. IEEE Standard 802.11h, for example, defines a channel switch announcement information element and frame to be broadcasted in one hop communications. The IAP 106 should send similar information to it associated nodes 102, 106 and 107 to inform the bound APs 106, in particular, of the channel swtiching. Furthermore, IAP 106 sends this information to neighbor IAPs 106 through wireless or wireline communications.

Table of Channel Information

The channel table of the one or more APs 106 as discussed above has, for example, information including one or more of the following seven types or categories of information. In particular, the first six categories of information are the aggregated channel information that is updated every time a management frame or a scan summary is received from a node 102, 106 or 107 in the corresponding channel The seventh category of information is the individual information for the APs 106 heard in the corresponding channel. The categories of information are as follows:
1. Channel number as described, for example, in the IEEE 802.11 Standard)
2. Channel information as described, for example, in the IEEE 802.11h and 802.11k Standards, or vendor specific information.
3. Neighborhood information
It is suitable, for example, for clear channel assessment (CCA) and/or network allocation vector (NAV) reports to be used for this purpose. Moreover, a neighborhood congestion metric can be used as described below:

$$Neighborhood congestion = Moving average of channel load ( CCA or NAV report value ) = CL\_ave ( t ) = ( 1 - {λ}^{Δ t} ) CL ( t ) + {λ}^{Δ t} CL\_ave ( t - Δ t )$$
where CL(t) is the channel load, CL_ave(t) is the average of the channel load, and Δt is the last time the channel congestion metric for that channel is updated and λ is a weighting factor. It is noted that if individual link information is available, the neighborhood congestion metric can be integrated into the link quality as described below. The value of λ should be chosen different for channel information obtained through actual scanning and obtained from other nodes' measurements. For example, default values for λ can be ⅝ if the node itself scanned the channel and ⅜ if the measurement is from another node. Although other nodes' measurement cannot reflect the accurate point of view of the AP 106 under consideration, those measurements can help to reduce the scanning overhead by reducing the channel list to be scanned.
4. Last update time with the following flags:
   a. Scanned flag when the AP 106 itself scanned
   b. Not-scanned flag when information is from other nodes' scan results
The last update time can be used to check the timeout values to remove stale information if the individual information of the nodes 102, 106 or 107 transmitting over that channel is not retained (i.e., if the HW sends only a scan summary for the aggregated channel information). This flag will also distinguish between actual scan versus obtaining channel information from other nodes. Moreover, this information can be used to determine actual link quality and avoiding mis-measurements and malicious nodes' activity.
5. State information (infrastructure versus ad-hoc mode) The state is an infrastructure state if at least one IAP 106 is found in a particular channel.
6. Site information
This metric can be used to estimate overall network status. For example, in the infrastructure state, an IAP 106 may compute and distribute this metric including the number of bound APs 106 and the traffic load at the gateway (e.g., IAP 106). In the ad-hoc state, out of band signaling to distribute number of BSSs may be used. In the infrastructure state, this information may be exchanged between IAPs 106, for example, for load balancing. IAPs 106 can distribute this information in the backhaul autonomously or upon requests by APs 106. The neighbor network segments can be distinguished from the completely connected nodes by matching network identification information (IDs) with the discovered nodes by using a priori information from other nodes or by actual scan results, or by matching information pertaining to the location of the nodes in the network.
7. Neighbor (AP or IAP) information including:
   a. MAC address (BSSID)
   b. SSID
   c. Device type
   d. State information (infrastructure/ad-hoc)
   e. Address of the bound IAP 106 (if an infrastructure mode)
   f. Number of hops to the IAP 106 (if an infrastructure mode)
   g. Route metric to the IAP 106 (if an infrastructure mode)
   h. Next hop address to the IAP 106 (if an infrastructure mode)
   i. Routing metrics to the neighbor
   j. Link quality between the current node and the neighbor (provided and updated by Adaptive Transmission Protocol (ATP))
   k. Lifetime (expiration or deletion time from the channel table)
   l. Other information including extended network ID, security information, capability information, supported physical (PHY) features (such as supported rates) and so on.

It should be noted that the above information is only maintained for legitimate APs 106, and the link quality and routing metrics can be obtained through actual scanning. Link quality can be computed as defined in the asynchronous transfer protocol (ATP) as understood in the art. Also, since information pertaining to a maximum amount of neighbors can be maintained, entries can be removed if, for example, so that the list does not exceed its maximum size. For example, if a new neighbor is an infrastructure device (e.g., IAP 106), a neighbor which is not an infrastructure device in that channel may be removed from the table information so that the new infrastructure device may be then added to the table. If the new neighbor is a non infrastructure device, it can simply ignored, especially if the table is at its maximum number of entries. Also, if there are channels where an IAP 106 is discovered, channels without an IAP 106 may be removed, or not added at all to the table.

The channel information that includes the neighbors and the current neighbor table that may be used for adaptive transmission protocol and routing algorithms may be kept separately or may be merged. A neighbor can be added in the table if a “hello” message is received by an AP 106 from the neighbor. Alternatively, if an IEEE Standard 802.11 management frame with information of a “hello” message is received from a neighbor communication on the same channel as an AP 106, that AP 106 can add that entry to its table. An AP 106 can include a neighbor handling module that can maintain separate expiry timers for information pertaining to each neighbor. The timers are updated every time a “hello” or an IEEE Standard 802.11 management frame with information of an “hello” message is received or a directed message is received from the neighbor. Possible neighbor and routing next hop candidates can be tracked from the channel information table. Once the channel switching is finished, the list of neighbors for routing can be determined from those operating on the selected channel.

The following provides four examples of the times during which the channel table can be updated.
1. When the HW scans the channel upon request from the MCX. This is used for initial network formation and before an AP 106 decides to switch the channel, and the values can be updated after the channel switching has occurred. Furthermore, an AP 106 may scan the channel at different periods:

a. If the AP 106 is in infrastructure mode, it can scan periodically the desired channels. The period (Pₛᵢ), in this regard, can be adaptive. For example, if the current cost metric (C) defined below is low, then the period can be reduced as follows:

If C<Cₜₕᵣₑₛₕ_{_{—}}₁

Pₛᵢ_{_{—}}₁=A1

Else

Pₛᵢ_{_{—}}₁=B1

With period A1 being less than period B1. The periodic scanning may be optimized according to traffic conditions.
b. If the AP 106 is in ad-hoc state, it will scan periodically (with Pₛₐ_{_{—}}₁) if no other information is available.
2. When the MCX requests an AP 106 to ask another node to scan the channel and receives the corresponding report from the other node. These processes can be optimized by selecting nodes that have capability and capacity to make the required measurements. For this purpose, an STA can maintain an average traffic load, T_ave(t), for each STA in the following manner:
   T_ave(t)=(1−λ^{Δt})T(t)+λ^{Δt}T_ave(t−Δt)
where Δt is the time that elapsed since the last time T_ave is updated and λ is a weighting factor as discussed above. T(t) may be increased by 1 for each transmission or by the packet duration and set to zero when the traffic load value is checked for measurement requests. T(t) may also be set to Δt to reflect the interarrival times of transmissions.

a. If the AP 106 is in infrastructure mode, it can send the following request:

If C<Cₜₕᵣₑₛₕ_{_{—}}₂

Pₛᵢ_{_{—}}₂=A2

Else

Pₛᵢ=B2

With period A2 being less than period B2. The periodic scanning may be optimized according to traffic conditions.
b. If the AP 106 is in ad-hoc state, it can send this request periodically (with Pₛₐ_{_{—}}₂) if no other information is available.
3. When the AP 106 receives an autonomous report from management frames received from the current channel.
4. When the HW implements its own scanning algorithm and sends the scan and switch results to the MCX. It should be noted that although cases 2 and 3 discussed above minimize the scanning overhead, it is preferred that the AP 106 scan the channel before switching to it in order to avoid security and mismeasurement issues. Moreover, an AP 106 can minimize the scanning overhead by scanning only the preferred channels.

For cases 3 and 4, the MCX may process the frames and scan result by checking the last update time or information change to reduce the processing overhead.

Evaluation Metrics:

It is noted that according to an embodiment of the present invention, any of the following three metrics can be used to achieve a desired network formation or network change.
1. Neighborhood metric
This metric can be used to estimate the communications quality between AP 106 and its neighbors (such as bound STAs and neighbor APs). Measurements such as channel load, interference level can be used to estimate the neighborhood metric.
2. Routing metric (including next hop link metric)
This metric can be used to estimate the communications quality between AP 106 and its routes, such as bound IAP 106. The routing metric can be used for this purpose. A link metric obtained from management frames can be used to select the best candidate for next hop.
3. Site metric
This metric can be used to estimate overall network status. For example, in the infrastructure state, IAP 106 may compute and distribute this metric including, for example, the number of bound APs 106 and/or the traffic load at the gateway. In the ad-hoc state, out of band signaling to distribute number of BSS's may be used.

In addition, channel selection can be performed according to the rules described above. A cost metric (C) based on the average channel load and the next hop link metric to select the best channel also may be used. This metric can also be used to select the channels to be scanned.

For example, C may be computed as:
C=wᵣmᵣ+wₙCL_ave
where mᵣ is the route metric while wᵣ and wₙ are weight values to normalize and weight mᵣ and CL_ave respectively. CL_ave is the neighborhood congestion as described in the previous section.

Other cost metrics as defined in a U.S. patent application entitled “System and Method for Providing a Congestion-Aware Routing Metric for Selecting a Route Between Nodes in a Multi-Hop Communication Network” (Attorney Reference Mesh-123) assigned to the assignee of the present invention and filed concurrently herewith, the entire content of which is incorporated by reference, can be used for this purpose. It will be appreciated by those of ordinary skill in the art that the difference in metrics typically should be larger then a threshold to decide switching.

Effect of Network Selection on the System:

Another important point for DFS methods is the admission scheme to avoid network degradation due to the additional BSS's in the multihop networks. As demonstrated above, an embodiment of the invention can be used efficiently to estimate the impact of the new traffic on the existing traffic. Some of the information such as neighborhood congestion level, congestion metric in routing metric and IAP 106 load in site information can enable the new AP 106 to avoid congested networks as described below.
1 Neighborhood metric
If an AP 106 has associated STAs that are likely to switch the channel selected by the AP, then traffic load in the BSS will affect the neighborhood congestion level.
2 Routing metric (including next hop link metric)
Accordingly, the new traffic going out of BSS (to the gateway) will increase the congestion level on the selected route.
3 Site metric
A new AP 106 bound to an IAP 106 or a new BSS merged with other BSS's will affect the overall network load.

However the additional elements pertaining to an existing network the network formation by extending the coverage of the network, reducing the number of hops for certain traffic, and so on. The impact of the channel selection on the existing network could be estimated for other situations such as when an AP 106 is the neighbor of two non-neighbor APs 106 bound with two different IAPs 106 in the same channel or when an AP 106 is the neighbor of two APs in ad-hoc state and with non-overlapping BSSs in the same channel.

In the foregoing specification, specific embodiments of the present invention have been described. However, one of ordinary skill in the art appreciates that various modifications and changes can be made without departing from the scope of the present invention as set forth in the claims below. Accordingly, the specification and figures are to be regarded in an illustrative rather than a restrictive sense, and all such modifications are intended to be included within the scope of present invention. The benefits, advantages, solutions to problems, and any element(s) that may cause any benefit, advantage, or solution to occur or become more pronounced are not to be construed as a critical, required, or essential features or elements of any or all the claims. The invention is defined solely by the appended claims including any amendments made during the pendency of this application and all equivalents of those claims as issued.

What is claimed is:

1. A method for selecting a frequency for communication by at least one node in a wireless communication network, the method comprising:
maintaining at the node network channel information pertaining to a degree of channel performance in the network; and
selecting a frequency for communication by the node based on the network channel information.

2. A method as claimed in claim 1, further comprising:
updating the channel information based on channel messages received by the node.

3. A method as claimed in claim 2, further comprising:
selecting a different frequency for communication by the node based on the updated channel information.

4. A method as claimed in claim 1, further comprising:
operating the node to communicate with an access point in the wireless communication network using the selected frequency.

5. A method as claimed in claim 4, further comprising:
operating the node to select a different frequency based on the network channel information; and
operating the node to communicate with another access point in the network over the different frequency.

6. A method as claimed in claim 4, wherein:
the node is an access point.

7. A method as claimed in claim 1, wherein:
the channel information includes information pertaining to channel congestion.

8. A method as claimed in claim 1, wherein:
the node performs the method and selecting steps when the node attempts to perform initial communications in the network.

9. A method as claimed in claim 1, wherein:
the node performs the method and selecting steps when the node is attempting to associate with a different access point in the network after having been associated with an access point.

10. A method as claimed in claim 1, further comprising:
operating the node to communicate over the selected frequency with another node in an ad-hoc network within the wireless communication network.

11. A node in a wireless communication network, the node comprising:
a transceiver; and
a controller, adapted to maintain network channel information pertaining to a degree of channel performance in the network, and being further adapted to select a frequency for communication by the transceiver based on the network channel information.

12. A node as claimed in claim 11, wherein:
the controller is further adapted to update the channel information based on channel messages received by the transceiver.

13. A node as claimed in claim 12, wherein:
the controller is further adapted to select a different frequency for communication by the transceiver based on the updated channel information.

14. A node as claimed in claim 11, wherein:
the controller is further adapted to control the transceiver to communicate with an access point in the wireless communication network using the selected frequency.

15. A node as claimed in claim 14, wherein:
the controller is adapted to select a different frequency based on the network channel information, and is further adapted to control the transceiver to communicate with another access point in the network over the different frequency.

16. A node as claimed in claim 14, wherein:
the controller is further adapted to control the transceiver to communicate with an access point in the network to provide another node in the network access to a network other than the network via the transceiver and the access point.

17. A node as claimed in claim 11, wherein:
the channel information includes information pertaining to channel congestion.

18. A node as claimed in claim 11, wherein:
the controller is further adapted to select the frequency when the controller controls the transceiver to attempt to perform initial communications in the network.

19. A node as claimed in claim 11, wherein:
the controller is adapted to control the transceiver to communicate over the selected frequency with a new access point in the network to associate the node with that new access point and to disassociate the node from a previous access point.

20. A node as claimed in claim 11, wherein:
the controller is adapted to control the transceiver to communicate over the selected frequency with another node in an ad-hoc network within the wireless communication network.
